(19) United States
(12) Patent Application Publication
(10) Pub. No.: US 2020/0263059 A1
(43) Pub. Date: Aug. 20, 2020

(54) HOT MELT ADHESIVE FILMS COMPRISING BIOBASED EVA, METHODS AND ARTICLES THEREOF

(71) Applicant: Braskem S.A., Camaçari (BR)

(72) Inventor: Giancarlos Delevati, São Paulo (BR)

(73) Assignee: Braskem S.A., Camaçari (BR)

(21) Appl. No.: 16/791,788

(22) Filed: Feb. 14, 2020

Related U.S. Application Data
(60) Provisional application No. 62/805,687, filed on Feb. 14, 2019.

(51) Int. Cl. C09J 7/35; C09J 123/08; C09J 131/04

(52) U.S. Cl. CPC C09J 7/35; C09J 123/08; C09J 2431/00; C09J 2423/04; C09J 131/04

(57) ABSTRACT

Hot melt adhesive film compositions may include a biobased ethylene vinyl acetate (EVA) copolymer containing a biobased carbon content as determined by ASTM D6866 of 5% to 95%; and a melt index (I₂) as determined by ASTM D1238 in the range of 1.5 g/10 min to 50 g/10 min measured with a load of 2.16 kg at 190° C. Methods may include a process for bonding a substrate to a similar or dissimilar substrate that includes applying to at least one substrate a hot melt adhesive film composition and bonding said substrate together, said hot melt adhesive film composition containing a biobased ethylene vinyl acetate copolymer.

### BACKGROUND

Polyolefins and polyolefin copolymers such as ethylene vinyl acetate (EVA) are widely used plastics worldwide, given their versatility in a wide range of applications, including the manufacture of articles, films, adhesive compositions, molded products, foams, and the like. The increasing complexity of manufactured goods has lead to major improvements and developments, particularly in the hot melt adhesive industry. Hot melt adhesives are being used to bond a wider variety of substrates, within a broader adhesive application process window, and for a large end-use portfolio. During application, hot melt adhesives are often heated and sprayed or coated as a film, which means that the adhesive must perform well during melting, transport, and application at the final location where the bond is desired. In addition, the adhesive needs to fulfill multiple requirements once set, which may include suitable bond strength, resistance to peeling, bond retention under or after mechanical stress, and under or after various thermal conditions.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to hot melt adhesive film compositions that include a biobased ethylene vinyl acetate (EVA) copolymer containing a biobased carbon content as determined by ASTM D6866 of 5% to 95%; and a melt index (I₂) as determined by ASTM D1238 in the range of 1.5 g/10 min to 50 g/10 min measured with a load of 2.16 kg at 190° C.

In another aspect, embodiments disclosed herein relate to hot melt adhesive film compositions that include hot melt adhesive film compositions containing a biobased ethylene vinyl acetate (EVA) copolymer at an amount ranging from 30 to 80 wt % of the hot melt adhesive film composition, wherein the biobased EVA exhibits a melt index (I₂) as determined by ASTM D1238 in the range of 1.5 to 50 g/10 min measured with a load of 2.16 kg at 190° C.; and a tackfier at an amount ranging from 10 to 40 wt % of the hot melt adhesive film composition.

In another aspect, embodiments disclosed herein relate to multi-layer articles, containing a hot melt adhesive film compositions that include a biobased ethylene vinyl acetate (EVA) copolymer containing a biobased carbon content as determined by ASTM D6866 of 5% to 95%; and a melt index (I₂) as determined by ASTM D1238 in the range of 1.5 g/10 min to 50 g/10 min measured with a load of 2.16 kg at 190° C.

In another aspect, embodiments disclosed herein relate to multi-layer articles, containing hot melt adhesive film compositions that include hot melt adhesive film compositions containing a biobased ethylene vinyl acetate (EVA) copolymer at an amount ranging from 30 to 80 wt % of the hot melt adhesive film composition, wherein the biobased EVA exhibits a melt index (I₂) as determined by ASTM D1238 in the range of 1.5 to 50 g/10 min measured with a load of 2.16 kg at 190° C.; and a tackfier at an amount ranging from 10 to 40 wt % of the hot melt adhesive film composition.

In another aspect, embodiments disclosed herein relate to a process for bonding a substrate to a similar or dissimilar substrate that includes applying to at least one substrate a hot melt adhesive film composition and bonding said substrate together, said hot melt adhesive film composition containing a biobased ethylene vinyl acetate copolymer.

Other aspects and advantages of the claimed subject matter will be apparent from the following description and the appended claims.

### DETAILED DESCRIPTION

In one aspect, embodiments disclosed herein relate to hot melt adhesive compositions containing ethylene vinyl acetate (EVA) copolymers. Hot melt adhesive compositions may contain a portion of biobased EVA copolymer that is derived from renewable source of carbon, such as a plant-based material. In some embodiments, adhesive compositions may be formulated to prepare adhesive films for a number of common substrates such as woven, nonwoven fabrics, expanded and crosslinked EVA, and polymeric materials.

Embodiments of the present disclosure are also directed to processes for creating multilayer structures by using a hot melt adhesive composition based on renewable carbon sources to bond one or more substrate layers together. In one or more embodiments, processes may include bonding a substrate to a similar or dissimilar substrate by applying a molten hot melt adhesive film composition to a substrate and bonding the treated substrate to a second substrate.

Hot melt adhesive compositions in accordance with the present disclosure may be formulated with at least part of a fraction of biobased ethylene vinyl acetate (EVA) as a replacement for (or in addition to) EVA copolymers derived from petrochemical sources. As used herein, “biobased EVA” is an EVA wherein at least one of ethylene and/or vinyl acetate monomers constituting the copolymer are derived from renewable sources, such as ethylene derived from biobased ethanol.

The use of products derived from natural sources, as opposed to those obtained from fossil sources, as raw material, has increasingly been a widely preferred alternative, as an effective means of reducing the atmospheric carbon dioxide concentration increase, therefore effectively preventing the expansion of the so called greenhouse effect. Adhesive compositions in accordance with the present disclosure may reduce the overall impact on carbon dioxide levels by incorporating a portion of materials obtained from renewable carbon sources. This renewable carbon content can be certified by the methodology described in the technical ASTM D 6866-06 Standard, “Standard Test Methods for Determining the Biobased Content of Natural Range Materials Using Radiocarbon and Isotope Ratio Mass Spectrometry Analysis.”

In one or more embodiments, adhesive compositions may be formulated with various performance modifiers that include tackifier resins and polar adjuncts to tailor the adhesive compositions for particular applications. Each of the components will be discussed in detail in the following sections.

Biobased EVA Copolymer

Hot melt adhesive compositions in accordance with the present disclosure may include one or more ethylene vinyl acetate (EVA) copolymers incorporating various ratios of ethylene and vinyl acetate, and may include one or more additional comonomers in some embodiments, wherein at least a portion of the EVA copolymers may be derived from renewable sources such as biobased EVA, which may be used alone or in combination with EVA copolymers derived from fossil sources.

Adhesive film compositions in accordance with the present disclosure may include biobased EVA copolymers incorporating various ratios of ethylene and vinyl acetate. In one or more embodiments, adhesive film compositions in accordance with the present disclosure may include a biobased EVA copolymer, wherein the percent by weight (wt %) of ethylene in the biobased EVA ranges from a lower limit selected from any one of 55 wt %, 60 wt %, 66 wt %, and 72 wt %, to an upper limit selected from any one of 80 wt %, 82 wt %, 88 wt %, and 92 wt %, where any lower limit may be paired with any upper limit. Similarly, adhesive film compositions in accordance with the present disclosure may include a biobased EVA copolymer having a wt % of vinyl acetate content as determined by ASTM D5594 that ranges from a lower limit selected from any one of 8 wt %, 12 wt %, 18 wt %, 20 wt %, 26 wt %, and 28 wt % to an upper limit selected from any one of 28 wt %, 33 wt %, 35 wt %, 40 wt %, and 45 wt %, where any lower limit may be paired with any upper limit. In some embodiments, biobased EVA may be selected from commercially available resins by Braskem such as SVT2180 or SVT2145R.

Biobased EVA copolymers may have a biobased carbon content as determined by ASTM D6866 that ranges from a lower limit selected from any one of 5%, 10%, 20%, 40%, and 55%, to an upper limit selected from any one of 60 wt %, 80 wt %, 95 wt %, and 99 wt %, where any lower limit may be paired with any upper limit. The total biobased or renewable carbon in the EVA polymer may be contributed from a biobased ethylene and/or a biobased vinyl acetate. It is understood that if at least a portion of the ethylene and/or the vinyl acetate is derived from a renewable source, it can be considered a biobased EVA, even if a fossil based ethylene and/or vinyl acetate is present in the polymerization process. Each of these are described in greater detail below. Further, while particular embodiments of the present disclosure may be directed to use of biobased EVA copolymers in the production of hot melt adhesive compositions, it is also understood that one or more other components may also be formed from renewable sources or one or more other components may be formed from fossil sources. The total biobased carbon content of the final composition and article, discussed below, may thus be based on consideration of all components.

Sources of renewable carbon for ethylene and vinyl acetate used to produce biobased EVA copolymers may include plant-based sources such as sugar cane and sugar beet, maple, date palm, sugar palm, sorghum, American agave, corn, wheat, barley, sorghum, rice, potato, cassava, sweet potato, algae, fruit, materials comprising cellulose, wine, materials comprising hemicelluloses, materials comprising lignin, wood, straw, sugarcane bagasse, sugarcane leaves, corn stover, wood residues, paper, and combinations thereof.

In one or more embodiments, a biobased ethylene may be obtained by fermenting a renewable source of carbon to produce ethanol, which may be subsequently dehydrated to produce ethylene. Further, it is also understood that the fermenting produces, in addition to the ethanol, byproducts of higher alcohols. If the higher alcohol byproducts are present during the dehydration, then higher alkene impurities may be formed alongside the ethanol. In one or more embodiments, the ethanol may be purified prior to dehydration to remove the higher alcohol byproducts while in other embodiments, the ethylene may be purified to remove the higher alkene impurities after dehydration.

Biologically sourced ethanol, known as bio-ethanol, is obtained by the fermentation of sugars derived from cultures such as that of sugar cane and beets, or from hydrolyzed starch, which is, in turn, associated with other cultures such as corn. It is also envisioned that the biobased ethylene may be obtained from hydrolysis based products from cellulose and hemi-cellulose, which can be found in many agricultural by-products, such as straw and sugar cane husks. This fermentation is carried out in the presence of varied microorganisms, the most important of such being the yeast Saccharomyces cerevisiae. The ethanol resulting therefrom may be converted into ethylene by means of a catalytic reaction at temperatures usually above 300° C. A large variety of catalysts can be used for this purpose, such as high specific surface area gamma-alumina. Other examples include the teachings described in U.S. Pat. Nos. 9,181,143 and 4,396,789, which are herein incorporated by reference in their entirety.

Biobased EVA copolymers of the present disclosure may also be derived from biobased vinyl acetate monomers in some embodiments. Biobased vinyl acetate may be produced by producing acetic acid by oxidation of ethanol (which may be formed as described above) followed by reaction of ethylene and acetic acid to acyloxylate the ethylene and arrive at vinyl acetate. Further, it is understood that the ethylene reacted with the acetic acid may also be formed from a renewable source as described above. Additional details about oxidation of ethanol to form acetic acid may be found in U.S. Pat. No. 5,840,971 and Selective catalytic oxidation of ethanol to acetic acid on dispersed Mo—V—Nb mixed oxides. Li X, Iglesia E. Chemistry; 2007; 13(33):9324-30.

Vinyl acetate in accordance with the present disclosure may also be generated by the esterification of acetic acid obtained from a number of natural sources, including conversion of fatty acid, as described in The Production of Vinyl Acetate Monomer as a Co-Product from the Non-Catalytic Cracking of Soybean Oil, Benjamin Jones, Michael Linnen, Brian Tande and Wayne Seames, Processes, 2015, 3, 61-9-633. Further, the production of acetic acid from fermentation performed by acetogenic bacteria, as described in Acetic acid bacteria: A group of bacteria with versatile biotechnological applications, Saichana N, Matsushita K, Adachi O, Frébort I, Frebortova J.; Biotechnol Adv. 2015 Nov. 1; 33(6 Pt 2):1260-71 and Biotechnological applications of acetic acid bacteria. Raspor P, Goranovic D. Crit Rev Biotechnol.; 2008; 28(2):101-24.

Adhesive compositions in accordance with the present disclosure may contain an biobased EVA copolymer at a percent by weight (wt %) of the composition that ranges from a lower limit of 20 wt %, 30 wt %, 40 wt %, or 50 wt %, to an upper limit of 60 wt %, 70 wt %, 80 wt %, 90 wt % or 100 wt %, where any lower limit may be paired with any upper limit.

Biobased EVA copolymers in accordance with the present disclosure may have a melt index (I₂) as determined by ASTM D1238 with a load of 2.16 kg at 190° C. that may range of a lower limit selected from any one of 1.5 g/10 min, 2.0 g/10 min and 3.0 g/10 min, to an upper limit selected from any one of 5 g/10 min, 10 g/10 min, 20 g/10 min, 25 g/10 min, 40 g/10 min, and 50 g/10 min, where any lower limit can be used with any upper limit. In particular embodiments, a biobased EVA copolymer may have a vinyl acetate content as determined by ASTM D5594 of 17 wt % to 21 wt %; and a melt index (I₂) as determined by ASTM D1238 in the range of 1.5 g/10 min to 5 g/10 min measured with a load of 2.16 kg at 190° C.

Biobased EVA copolymers, in accordance with the present disclosure may have a density as determined by ASTM D1505/D792 that may range of a lower limit selected from any one of 0.9 g/cm³, 0.91 g/cm³, and 0.92 g/cm³ to an upper limit selected from any one of 0.95 g/cm³, 0.96 g/cm³, or 0.97 g/cm³, where any lower limit can be used with any upper limit.

Adhesive film compositions in accordance with the present disclosure may include a biobased EVA copolymer having a number average molecular weight (Mn) in kilodaltons (kDa) that ranges from a lower limit selected from one of 5 kDa, 10 kDa, 20 kDa and 25 kDa to an upper limit selected from one of 30 kDa, 35 kDa, 40 kDa and 50 kDa, where any lower limit may be paired with any upper limit.

Adhesive film compositions in accordance with the present disclosure may include a biobased EVA copolymer having a weight average molecular weight (Mw) in kilodaltons (kDa) that ranges from a lower limit selected from one of 25 kDa, 50 kDa, 70 kDa, 90 kDa and 110 kDa to an upper limit selected from one of 120 kDa, 140 kDa, 150 kDa and 180 kDa, where any lower limit may be paired with any upper limit.

Adhesive film compositions in accordance with the present disclosure may include a biobased EVA copolymer having a dispersity (Mw/Mn) that ranges from a lower limit selected from one of 1.0, 1.5, 3.0 and 4.0 to an upper limit selected from one of 5.0, 6.0, 7.0 and 8.0, where any lower limit may be paired with any upper limit.

In one or more embodiments, an adhesive composition may contain a biobased EVA copolymer a percent by weight (wt %) of the composition that ranges from a lower limit of 20 wt %, 30 wt %, 40 wt %, or 50 wt %, to an upper limit of 60 wt %, 70 wt %, 80 wt %, or 90 wt %, where any lower limit may be paired with any upper limit.

Fossil EVA Copolymer

In one or more embodiments, EVA copolymer component of an adhesive composition may contain a mixture of biobased EVA and “fossil EVA” copolymers derived from traditional fossil fuel sources or otherwise differentiated from the biobased EVA described above. In some embodiments, an adhesive composition may contain a fossil EVA copolymer a percent by weight (wt %) of the composition that ranges from a lower limit of 15 wt %, 20 wt %, 25 wt %, or 30 wt %, to an upper limit of 30 wt %, 35 wt %, 40 wt %, or 50 wt %, where any lower limit may be paired with any upper limit. In particular embodiments, hot melt adhesive film compositions in accordance with the present disclosure may include 20 to 40 wt % of fossil EVA.

In particular embodiments, fossil EVA copolymers in accordance with the present disclosure may include a percent by weight (wt %) of vinyl acetate as determined by ASTM D5594 that ranges from a lower limit selected from any one of 12 wt % 17 wt %, 20 wt %, 26 wt %, 28 wt %, and 35 wt %, to an upper limit selected from any one of 30 wt %, 35 wt %, 40 wt %, and 45 wt %, where any lower limit may be paired with any upper limit.

In particular embodiments, fossil EVA copolymers in accordance with the present disclosure may have a melt index (I₂) as determined by ASTM D1238 as measured with a load of 2.16 kg at 190° C. that ranges from a lower limit selected from any one of 2 g/10 min, 2.3 g/10 min, 4.5 g/10 min, 5.0 g/10 min, 5.1 g/10 min, and 6 g/10 min, to an upper limit selected from 20 g/10 min, 25 g/10 min, 30 g/10 min, and 50 g/10 min, where any lower limit may be paired with any upper limit. In particular embodiments, adhesive compositions may include a fossil EVA that exhibits a vinyl acetate content as determined by ASTM D5594 of 26 to 45 wt %, and a melt index (I₂) as determined by ASTM D1238 in the range of 2.3 to 50 g/10 min measured with a load of 2.16 kg at 190° C. In some embodiments, fossil EVA resins may be selected from commercially available resins by Braskem such as VA4018R, HM728, 3019PE, 8019PE, PN2021, HM150, HM728F, and HM2528.

Fossil EVA copolymers, in accordance with the present disclosure may have a density as determined by ASTM D1505/D792 that may range of a lower limit selected from any one of 0.91 g/cm³, 0.915 g/cm³ and 0.92 g/cm³ to an upper limit selected from any one of 0.95 g/cm³, 0.96 g/cm³, or 0.97 g/cm³, where any lower limit can be used with any upper limit.

Adhesive film compositions in accordance with the present disclosure may include an EVA copolymer having a number average molecular weight (Mn) in kilodaltons (kDa) that ranges from a lower limit selected from one of 5 kDa, 10 kDa, 20 kDa and 25 kDa to an upper limit selected from one of 30 kDa, 35 kDa, 40 kDa and 50 kDa, where any lower limit may be paired with any upper limit.

Adhesive film compositions in accordance with the present disclosure may include an EVA copolymer having a weight average molecular weight (Mw) in kilodaltons (kDa) that ranges from a lower limit selected from one of 25 kDa, 50 kDa, 70 kDa, 90 kDa and 110 kDa to an upper limit selected from one of 120 kDa, 140 kDa, 150 kDa and 180 kDa, where any lower limit may be paired with any upper limit.

Adhesive film compositions in accordance with the present disclosure may include an EVA copolymer having a dispersity (Mw/Mn) that ranges from a lower limit selected from one of 1.0, 1.5, 3.0 and 4.0 to an upper limit selected from one of 5.0, 6.0, 7.0 and 8.0, where any lower limit may be paired with any upper limit.

Tackifier

Tackifiers in accordance with the present disclosure may be a chemical compound or low molecular weight polymer that enhances the adhesion of a hot melt adhesive composition. Tackifiers include any compatible resins or mixtures thereof such as natural and modified rosins including gum rosin, wood rosin, tall oil rosin, distilled rosin, hydrogenated rosin, dimerized rosin, rosin esters, and polymerized rosin; glycerol and pentaerythritol esters of natural and modified rosins, including phenolic-modified rosins and rosin esters; monomeric resins; polymers and copolymers of natural terpenes such as pinene; terpene resins; hydrogenated polyterpene resins; phenolic modified terpene resins and hydrogenated derivatives thereof; indene-coumarone resins; aliphatic petroleum hydrocarbon resins; hydrogenated aliphatic petroleum hydrocarbon resins; C5/C9 hydrocarbon resins, including cyclic or acylic C5 resins and aromatic modified acyclic or cyclic resins, cyclic petroleum hydrocarbon resins and the hydrogenated derivatives, and the like. In some embodiments, tackfiers may be selected from hydrocarbon resins. In other embodiments tackfiers may be selected from commercially available hydrocarbon resins by Braskem such as resins from the UNILENE® family, including Unilene A80, Unilene A90 or Unilene A100.

In some embodiments, an adhesive composition may contain a tackifier at a percent by weight (wt %) of the composition that ranges from a lower limit of 10 wt %, 15 wt %, 20 wt %, 25 wt %, or 30 wt %, to an upper limit of 30 wt %, 35 wt %, 40 wt %, or 50 wt %, where any lower limit may be paired with any upper limit.

In one or more embodiments, tackfiers may be formulated as a concentrate, or “tackifier masterbatch” that is combined with other polymers and/or additives to prepare a hot melt composition. Tackifier masterbatches may be prepared in any conventional mixing process of resins, such as solubilization and extrusion processes. In one or more embodiments, tackifier masterbatches may be formulated with tackfier and any suitable base polymer having good compatibility with the other components of the hot melt adhesive composition. In particular embodiments the base polymer is an EVA copolymer.

Tackfier masterbatches in accordance with the present disclosure may contain tackfiers at a percent by weight (wt %) of the masterbatch that ranges from 30 wt % to 70 wt % and a base polymer at a percent by weight (wt %) of the masterbatch that ranges from 30 wt % to 70 wt %.

In one or more embodiments, a hot melt adhesive composition may be combined with a tackifier masterbatch at a percent by weight (wt %) of a the adhesive composition that ranges from 20 wt % to 50 wt %.

Polar Adjuncts

Adhesive film compositions in accordance with the present disclosure may incorporate one or more polar adjuncts that may increase the polarity of the hotmelt adhesive film composition, which may in turn increase the adhesiveness with substrates through non-covalent interactions such as hydrogen bonding and Van der Waals forces. Polar adjuncts may include compounds having one or more polar functional groups such as hydroxyl, carboxylic acid, carboxylate, ester, ether, acetate, amide, amine, epoxy, imide, imine, sulfone, phosphine, and the like.

In one or more embodiments, polar adjuncts may include saturated and unsaturated polycarboxlyic acids having two or more carboxylic acid adjuncts, such as itaconic acid, citaconic acid, methyl glutamic acid, maleic acid, succinic acid, and the like; saturated and unsaturated anhydrides such as such as maleic anhydride, itaconic anhydride, citaconic anhydride, methyl glutamic anhydride, succinic anhydride; esters of carboxylic acids such as acrylate, methacrylates, 2-methylene glutarates, methylenesuccinates and phthalates; the acrylates and methacrylate esters of mono- or poly-hydroxy alcohols, such as alkoxy monoalcohols, glycols, triols and tetraols, acrylic acid or methacrylic acid, fumaric acid, 2-propene 1,2-dicarboxylic acid, undecenoic acid, and the like. In particular embodiments, polar adjuncts may include maleic anhydride, maleic acid, itaconic acid, itaconic anhydride, succinic acid, succinic anhydride, succinic aldehyde, adipic acid, adipic anhydride, phthalic anhydride, pthalic acid, and glutaraldehyde.

Other polar adjuncts in accordance with the present disclosure may include saturated and unsaturated esters and multiesters such as methoxy polyethylene glycol acrylates, ethoxy polyethylene glycol acrylates, ethylene glycol diacrylate, ethylene glycol dimethacrylate, polypropylene glycol diacrylate, polypropylene glycol dimethacrylate, 1,3-butylene glycol diacrylate, 1,3-butylene glycol dimethacrylate, neopentyl glycol diacrylate, neopentyl glycol dimethacrylate, trimethylol ethane triacrylate, trimethylol ethane trimethacrylate, trimethylol propane triacrylate, trimethylol propane trimethacrylate, and tetramethylol methane tetracrylate.

In one or more embodiments, polar adjuncts may include acrylate or methacrylate monomers functionalized with a primary and/or secondary amine, including 2-(N,N-dimethylamino)ethyl (meth)acrylate, 3-(N,N-dimethylamino)propyl (meth)acrylate, N′-(3-N,N-dimethylamino)propyl (meth)acrylamide, 2-(N,N-dimethylamino)ethyl methacrylate (DMAEMA), 2-(N,N-diethylamino)ethyl methacrylate (DEAEMA), 2-(tert-butylamino)ethyl methacrylate (TBAEMA), 2-(N,N-dimethylamino)propyl methacrylamide (DMAPMAm), 2-(N,N-dimethylamino)neopentyl acrylate (DMANPA), and the like.

In one or more embodiments, adhesive compositions in accordance with the present disclosure may contain a percent by weight (wt %) of one or more polar adjuncts that range from a lower limit selected from one of 0.001 wt %, 0.01 wt %, and 0.05 wt %, to an upper limit selected from one of 0.05 wt %, 0.1 wt % and 0.2 wt %, where any lower limit can be used with any upper limit.

Physical and Chemical Properties

In one or more embodiments, hot melt adhesive compositions may exhibit a biobased carbon content, as determined by ASTM D6866 of at least 5%. In some embodiments, hot melt adhesive film compositions may exhibit a biobased carbon content as determined by ASTM D6866 of at least 20%. Further, other embodiments may include at least 10%, 40%, 50%, 60%, 80%, or 90% biobased carbon, where the biobased carbon may be entirely contributed by the EVA copolymer or may also be contributed by other components as well.

Adhesive compositions in accordance with the present disclosure may have a bonding resistance as determined by ABNT NBR 10456 of at least 1 N/mm. In one or more embodiments, adhesive compositions may have a bonding resistance that ranges from a lower limit selected from any one of 0.5 N/mm, 1.0 N/mm, and 1.5 N/mm, to an upper limit selected from any one of 15 N/mm, 20 N/mm, and 25 N/mm, where any lower limit can be used with any upper limit.

Adhesive compositions in accordance with the present disclosure may have a Vicat softening point as determined by ASTM D1525 Method A50 that ranges from a lower limit selected from any one of 50° C., 60° C., and 70° C., to an upper limit selected from any one of 110° C., 120° C., and 130° C., where any lower limit can be used with any upper limit.

Additives

Adhesive film compositions in accordance with the present disclosure may include additives that modify various physical and chemical properties of an adhesive film composition during blending that include one or more polymer additives such as processing aids, lubricants, antistatic agents, clarifying agents, nucleating agents, beta-nucleating agents, slipping agents, antioxidants, compatibilizers, antacids, light stabilizers such as HALS, IR absorbers, whitening agents, inorganic fillers, organic and/or inorganic dyes, anti-blocking agents, processing aids, flame-retardants, plasticizers, biocides, adhesion-promoting agents, metal oxides, mineral fillers, glidants, oils, anti-oxidants, antiozonants, accelerators, and vulcanizing agents.

Applications

Adhesive films may be produced by blown film extrusion, where the components of the composition are initially mixed, extruded and formed into a blown film. However, it is also envisioned that the adhesive films may be produced by a cast film extrusion process.

Hot melt adhesives may be used to generate multilayer structures by bonding similar or dissimilar substrates, which may include applying a hot melt adhesive film composition to at least one substrate and bonding the layers together. For example, the film (or adhesive composition) may be melted and applied to the at least one substrate to which it is being bound. Application onto the substrate may be, for example, by use of a calender, a laminator (such as a flat bed laminator), by various welding techniques, or by various batch processes which may use a variety of heat sources. It is also envisioned that at least one release layer may be used. Substrates may take the form of films, blocks, sheets, fiber, thread, strip, ribbon, coating, foil, band, and the like. While there are no practical limits on the type of substrate that may be bonded using adhesive compositions in accordance with the present disclosure, exemplary substrates may include fabrics, non-woven materials, polymers and polymeric films such as polyurethane, EVA, polypropylene, polyethylene, polyvinylchloride, polyester, polyamide, polyolefin, polyacrylic, polyester, polyvinyl chloride, polystyrene, cellulosics such as wood, cardboard, paper and the like.

Although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

What is claimed:

1. A hot melt adhesive film composition comprising:
a biobased ethylene vinyl acetate (EVA) copolymer comprising:
a biobased carbon content as determined by ASTM D6866 of 5% to 95%; and
a melt index (I₂) as determined by ASTM D1238 in the range of 1.5 g/10 min to 50 g/10 min measured with a load of 2.16 kg at 190° C.

2. The hot melt adhesive film composition of claim 1, wherein at least a portion of ethylene from the biobased EVA copolymer is obtained from a renewable carbon source.

3. The hot melt adhesive film composition of claim 1, wherein at least a portion of vinyl acetate from the biobased EVA copolymer is obtained from a renewable carbon source.

4. The hot melt adhesive film composition of claim 1, wherein the biobased EVA comprises a vinyl acetate content as determined by ASTM D5594 of 12 wt % to 45 wt %.

5. The hot melt adhesive film composition of claim 1, further comprising a tackfier at an amount ranging from 10 wt % to 40 wt % of the hot melt adhesive film composition.

6. The hot melt adhesive film composition of claim 1, further comprising a fossil EVA copolymer at an amount that ranges from 20 to 40 wt % of the hot melt adhesive film composition.

7. A hot melt adhesive film composition comprising:
a biobased ethylene vinyl acetate (EVA) copolymer at an amount ranging from 30 to 80 wt % of the hot melt adhesive film composition, wherein the biobased EVA comprises a melt index (I₂) as determined by ASTM D1238 in the range of 1.5 to 50 g/10 min measured with a load of 2.16 kg at 190° C.; and
a tackfier at an amount ranging from 10 to 40 wt % of the hot melt adhesive film composition.

8. The hot melt adhesive film composition of claim 7, wherein the biobased EVA comprises a biobased carbon content as determined by ASTM D6866 of 5% to 95%.

9. The hot melt adhesive film composition of claim 7, wherein the biobased EVA comprises a vinyl acetate content as determined by ASTM D5594 of 12 wt % to 45 wt %.

10. The hot melt adhesive film composition of claim 7, further comprising a fossil EVA copolymer at an amount that ranges from 20 to 40 wt % of the composition.

11. The hot melt adhesive film composition of claim 10, wherein the fossil EVA exhibits a vinyl acetate content as determined by ASTM D5594 of 26 to 45 wt %, and a melt index (I₂) as determined by ASTM D1238 in the range of 2.3 to 50 g/10 min measured with a load of 2.16 kg at 190° C.

12. The hot melt adhesive film composition of claim 7, wherein the composition further comprises one or more polar adjuncts comprising one or more functional groups selected from a group consisting of hydroxyl, carboxylic acid, carboxylate, ester, ether, acetate, amide, amine, epoxy, imide, imine, sulfone, and phosphine, and wherein the one or more polar adjuncts are present at an amount that ranges from 0.001 to 0.1 wt % of the hot melt adhesive film composition.

13. The hot melt adhesive film composition of claim 12, wherein the one or more polar adjuncts are selected from the group consisting of maleic anhydride, maleic acid, itaconic acid, itaconic anhydride, succinic acid, succinic anhydride, succinic aldehyde, adipic acid, adipic anhydride, phthalic anhydride, pthalic acid, and glutaraldehyde.

14. The hot melt adhesive film composition of claim 7, wherein the biobased EVA copolymer has a vinyl acetate content as determined by ASTM D5594 of 17 to 21 wt %; and a melt index (I₂) as determined by ASTM D1238 in the range of 1.5 g/10 min to 5 g/10 min measured with a load of 2.16 kg at 190° C.

15. The hot melt adhesive film composition of claim 7, wherein the composition exhibits a Vicat softening point as determined by ASTM D1525 Method A50 in the range of 60° C. to 130° C.

16. The hot melt adhesive film composition of claim 7, wherein the composition exhibits a bonding resistance as determined by ABNT NBR 10456 of at least 1 N/mm.

17. A multi-layer article, comprising:
at least one layer of the hot melt adhesive film composition of claim 1; and
one or more substrate layers.

18. The article of claim 17, wherein the substrate layers are made from one or more materials chosen from a group consisting of fabric, non-woven materials, polyurethane, ethylene vinyl acetate copolymer, polypropylene, polyethylene, polyvinylchloride, polyester, and polyamide.

19. A process for bonding a substrate to a similar or dissimilar substrate comprising applying to at least one substrate a hot melt adhesive film composition and bonding said substrate together, said hot melt adhesive film composition comprising a biobased ethylene vinyl acetate copolymer.

20. The process of claim 19, wherein the hot melt adhesive film composition comprises the hot melt adhesive film composition of claim 1.
